(19) United States
(12) Patent Application Publication
(10) Pub. No.: US 2012/0113623 A1
(43) Pub. Date: May 10, 2012

(54) Solar Powered Lighting Assembly

(75) Inventor: James D. Weber, Kennewick, WA (US)

(73) Assignee: James D. Weber, Kennewick, WA (US)

(21) Appl. No.: 12/940,839

(22) Filed: Nov. 5, 2010

(51) Int. Cl. F21L 4/08

(52) U.S. Cl. 362/183

(57) ABSTRACT

A solar powered lighting assembly that can provide natural light and/or emitted light to the interior area of a building or other habitable structure and the power source may be a low voltage direct current power source or solar cells disposed within the lighting assembly.

### BACKGROUND

Habitable shelter is a common need throughout the world. The ability to provide water and power infrastructure to support large amounts of shelters may not be practical, available, or in some instances, desired. For example, large amounts of displaced refugees due to natural or man-made disasters results in an immediate need for habitable shelters. The water and power infrastructure to support that need may be unusable or may not even exist. Habitable structures that are easy to assemble and can be quickly delivered are desirable in responding to a humanitarian crisis. Even under normal (non-crisis) conditions domiciles that are self contained or self sufficient may be desirable due to, for example, remote location, unreliable delivery, of power water, or limited waste disposal options.

Without an existing utility infrastructure, the ability to provide water and power for individual shelters is problematic. Power provided by gasoline generators requires constant replenishment and an electrical network to provide power to individual shelters. Water provided by truck requires individual occupants to wait in line to receive water and limits their amount of water based on what they can carry back to their shelter.

### SUMMARY

This Summary is provided to introduce simplified concepts for an off-the-grid container shippable domicile that provides water and power without being connected external utilities. The habitable shelter may, but need not be connected to a utility grid for water and power. The methods and systems are described in greater detail below in the Detailed Description. This Summary is not intended to identify essential features of the claimed subject matter nor is it intended for use in determining the scope of the claimed subject matter. One or more other renewable energy sources may additionally or alternatively be provided, such as wind, geothermal, or the like.

The off-the-grid capabilities may include the use of a low power direct current electrical system for the habitable structure. Various low power energy storage devices can be stored in the house to provide power to the appliances and outlets included in the structure. Additionally, a solar power collection device can be used to supplement the energy storage devices or provide the primary source of power for the structure.

A water storage system for the structure may include bladders or other liquid-tight flexible containers that deliver potable water and collect gray water. A composting system may also be included to process any bio-degradable waste generated by the occupants of the structure.

The structure may also be substantially prefabricated to include the walls, floors, appliances, power and water distribution systems, and fixtures that may be included in any home or building. Further, in some embodiments, the structure may be shipped in a collapsed state that permits the entire structure to be shipped in a shipping container. Once the shipping container reaches its final destination, the collapsed structure can be removed from the container and converted to an expanded state that provides a habitable space that does not require connections to external fixed utilities for water, power, or fuel.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is an illustration of a representative habitable structure in an expanded state and a collapsed state according to one embodiment.

FIG. 2 is a schematic diagram representative of a habitable structure in an expanded state and a collapsed state according to one embodiment.

FIG. 3 is a schematic diagram representative of a water and fuel distribution system for the habitable structure according to one embodiment.

FIG. 4 is a schematic diagram representative of a power distribution system and a low power direct current power supply system for the habitable structure.

FIG. 5 is an illustration of a solar light system for the habitable structure.

FIG. 6 is a schematic diagram representative of an electronic device docking station integrated into the habitable structure.

FIG. 7 an illustration of an electrical receptacle and plug integrated into the habitable structure.

### DETAILED DESCRIPTION

### Overview

This disclosure relates to a habitable structure whose power and water supply is internal to the structure. In another embodiment, the structure may be a prefabricated structure that includes appliances and fixtures that may be assembled on site. Additionally, the habitable structure can be prefabricated into a collapsed state that permits the structure to be shipped in a standard shipping container. Once the prefabricated structure arrives on site, the structure may be removed from the container and expanded to provide habitable shelter for any occupants.

In one implementation, a prefabricated structure may be shipped in a collapsed state that enables the structure to be placed in a standard shipping container. Following removal from the shipping container, the structure may be assembled using the prefabricated components that incorporate electrical, water, and composting systems to provide a habitable structure that does not require connection to external utilities. Although external utilities are not required, the habitable structure may be configured to interface with external utilities if desired.

### Example Collapsible Structure

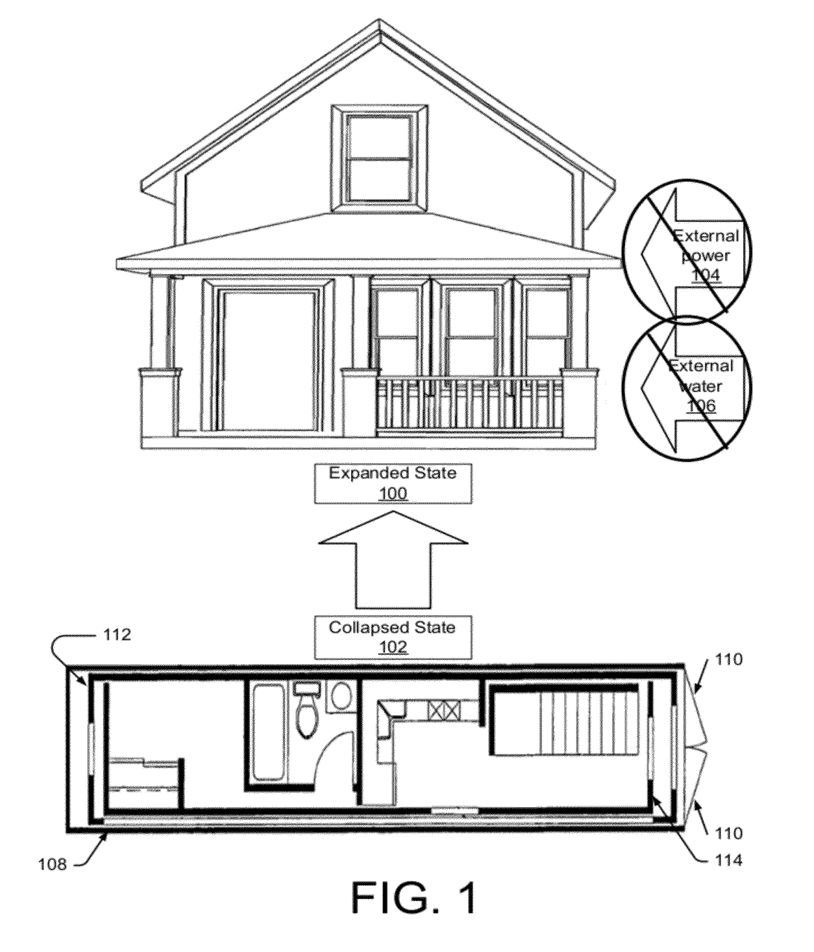

FIG. 1 is an illustration of a representative prefabricated structure shown in an expanded state 100 and a collapsed state 102. A prefabricated structure is a structure that is substantially assembled to include the structure and walls that can be organized into a completed structure. In another implementation, the prefabricated structure also includes the fixtures appliances and the utilities to provide water and/or power to the fixtures and appliances. The structure is habitable from the point of view of providing shelter for human occupants so that they can live, eat, sleep, and/or relax away from the elements.

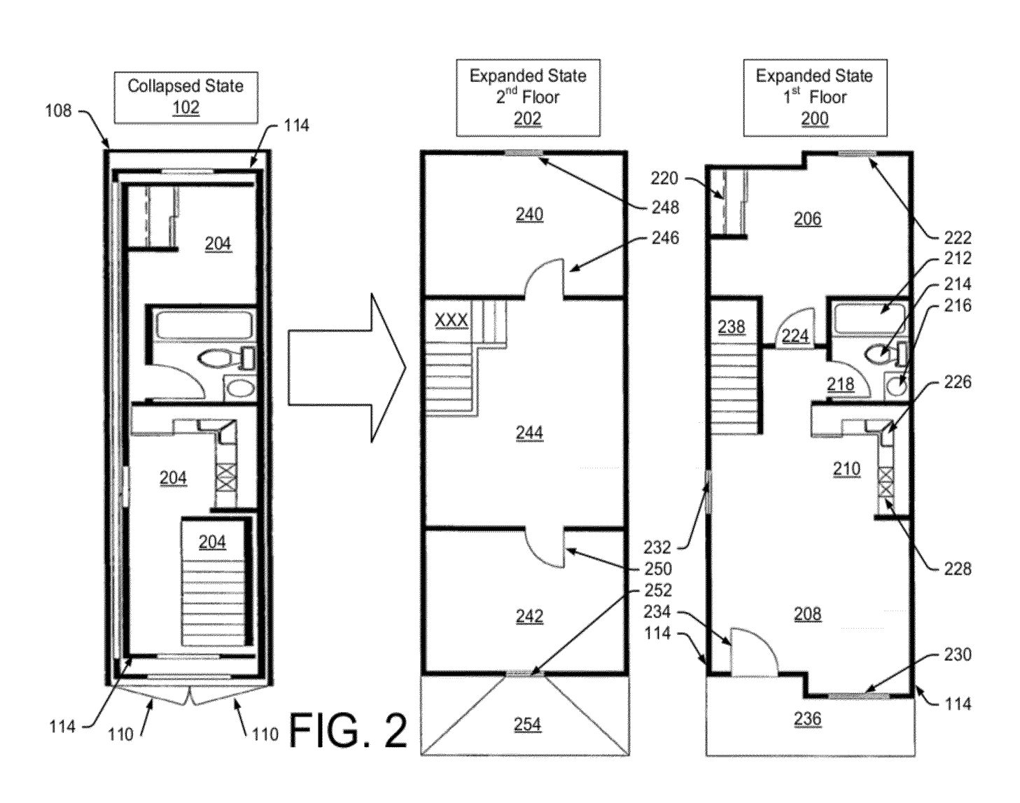

In one embodiment, in the expanded state 100 the structure is a two-story structure that does not require external power 104 or external water 106 connections. The two-story structure is provided for explanatory purposes and the structure may be a single story structure or a structure with three or more stories or levels. The collapsed state 102 illustration shows a shipping container 108 with doors 110. In one embodiment, the collapsed state structure 102 includes a stationary prefabricated structure 112 within which nests a movable prefabricated structure 114. The stationary prefabricated structure 112 is stationary relative to the moveable prefabricated structure 114. Naturally, the stationary prefabricated structure 112 may be moved out of the shipping container 108 once the container 108 has been delivered to its final destination. Once the stationary prefabricated structure 112 is set on its foundation the moveable prefabricated structure 114 is moved from its nested position within the stationary prefabricated structure 112 to a position alongside the stationary prefabricated structure 112. Details related to the positioning of the expanded state structure 100 and the prefabricated fixtures shown in the collapsed state structure 102 will be discussed further with reference to FIG. 2.

FIG. 2 includes illustrations of the collapsed state 102 and the layout of the expanded state first floor 200 and the expanded state second floor 202 of the prefabricated structure 100. The collapsed state 102 includes the shipping container 108 with its doors 110. In one embodiment, the empty areas 204 of the collapsed structure 102 may include building materials or other materials that are used in the assembly of the expanded state prefabricated structure 100. None of the materials are shown in the FIG. 2, but the empty spaces 204 provide examples of where such materials may be stored.

The first floor 200, in one embodiment, may include a bedroom 206, a living room 208, a kitchen 210, and a bathroom that includes a shower/tub 212, a composting system 214, a bathroom sink 216, and a door 218. The composting system 214 may process bio-degradable waste produced by human occupants or other bio-degradable waste not consumed by the occupants (e.g., food). The bedroom 206 may include a closet 220, a window 222, and a door 224. The kitchen 210 may include a kitchen sink 226 and a cooking range 228. Also, the kitchen 210 may include a refrigerator, a dishwasher, and other kitchen appliances that are not shown for the purpose of ease of illustration. The living room may include windows 230 and 232 and a door 234 that leads to a patio 236. The first floor may also include stairs 238 that lead to the second floor 202. Also, a water heater, a furnace, or an HVAC system may be stored or installed underneath the stairs 238. The aforementioned appliances are not shown for purposes of ease of illustration.

The second floor 202 is accessible via the stairs 238. In one embodiment, the second floor 202 may include bedrooms 240 and 242 and a second living area 244. Bedroom 240 may include a door 246 and a window 248. Bedroom 242 also may include a door 250 and a window 252 that looks out of over the roof of the patio 254.

The utility distributions systems that supply water or power to the appliances or fixtures that are integrated into the prefabricated structure 100 are not shown in FIG. 2, but they will be discussed in detail in the descriptions of the figures below.

### Example Utility Systems

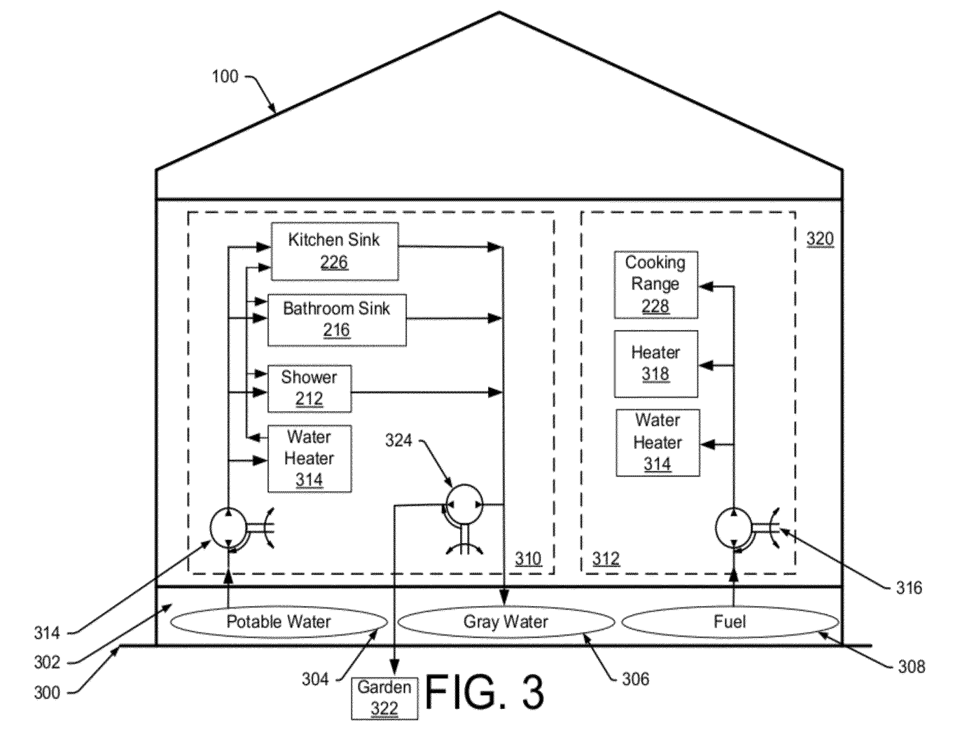

FIG. 3 includes a schematic representation of the expanded state structure or prefabricated structure 100 placed on a foundation 300. The prefabricated structure 100 may include an access space 302 that includes a potable water supply 304, a gray water supply 306, and a fuel supply 308. In one embodiment, the water and fuel are contained within separate bladders. However, in other embodiments, fuel and water may be held in container that are flexible or otherwise collapsible.

The prefabricated structure 100 may also include a water distribution system 310 and a fuel distribution system 312. In the illustrated example, both of the distribution systems 310 and 312 are integrated into the prefabricated structure 100 prior to shipping. By way of example, and not limitation, the water distribution system 310 may include a water pump 314 that provides potable water to the kitchen sink 226, the bathroom sink 216, the shower/tub 212, and a water heater 314. Also, the water delivery lines from the water heater 314 to the kitchen sink 226, the bathroom sink 216, and the shower/tub 212 are shown FIG. 3. Each of the aforementioned elements may also include a return line to the gray water supply 306, or in the case of the water heater 314, to supply hot water to the other elements.

In another embodiment, the gray water supply may also include a water pump and may further include supply lines to other appliances or fixtures that may use or process gray water. For example, the composting system 214 may use gray water if needed or the gray water may be provided to water a garden 322 or plants located in or around the prefabricated structure 100. The gray water pump and delivery system 324 enables the gray water delivery to the garden 322. The gray water could also be provided to a purification system (not shown). In one embodiment, the fuel distribution system 312 may include a fuel bladder 308 and a fuel pump 316 and a delivery network that provides fuel to the cooking range 228, a heater or furnace 318, and a water heater 314. In another embodiment, the water heater 314 may additionally or alternatively be may be connected to another energy source that may include solar or electrical power sources. Also, the occupants of the prefabricated structure 100 may connect the fuel distribution system 312 to any other fuel driven appliance or fixture that may be useful or desired.

In another embodiment, the potable water supply 304, the gray water supply 306, and the fuel supply 308 may be located above the interior habitable space 320, or in or on the walls of the prefabricated structure 100. Also, when the bladders are used in the walls they maybe used for bullet proofing the walls based on the material of the bladders and/or the contents of the bladders. This embodiment is not illustrated in FIG. 3.

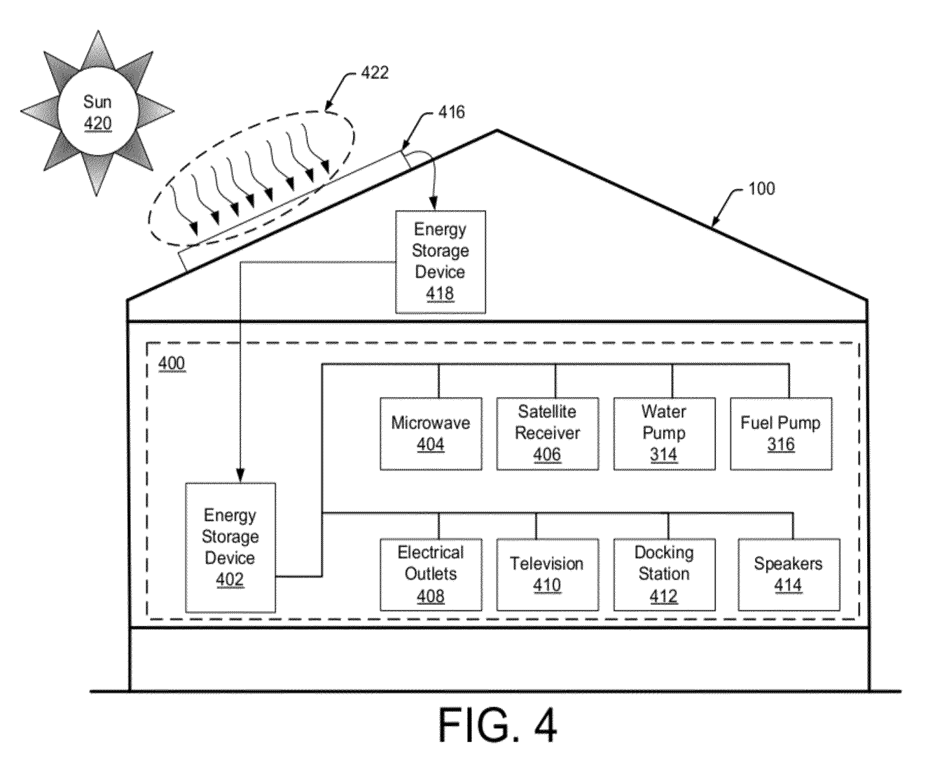

FIG. 4 is a schematic representation of an electrical delivery and supply system 400 for the prefabricated structure 100. The electrical delivery and supply system 400 may be integrated into the prefabricated structure prior to shipping or may be included in portions of the empty space 204 prior to shipping.

In one embodiment, an energy storage device 402 may be a low voltage direct current power source for the electrical delivery system 400. The energy storage device 402 may be a low voltage deep cycle battery, a fuel cell, thermal energy storage device or a combination of the foregoing. In one specific embodiment, the energy storage device 402 comprises a 12 volt operating voltage.

The electrical delivery system 400 may provide electrical power to any electrical device, appliance, or fixture desired by the occupants of the prefabricated structure 100. In one embodiment, example devices requiring electrical power may include a microwave 404, a satellite receiver 406, the water pump 314, the fuel pump 316, electrical outlets 408, a television 410, a docking station 412, and speakers 414. In another embodiment, the electrical outlets 408 may include connections to lights or fans included in the prefabricated structure 100. The additional lights and fans are not shown in FIG. 4.

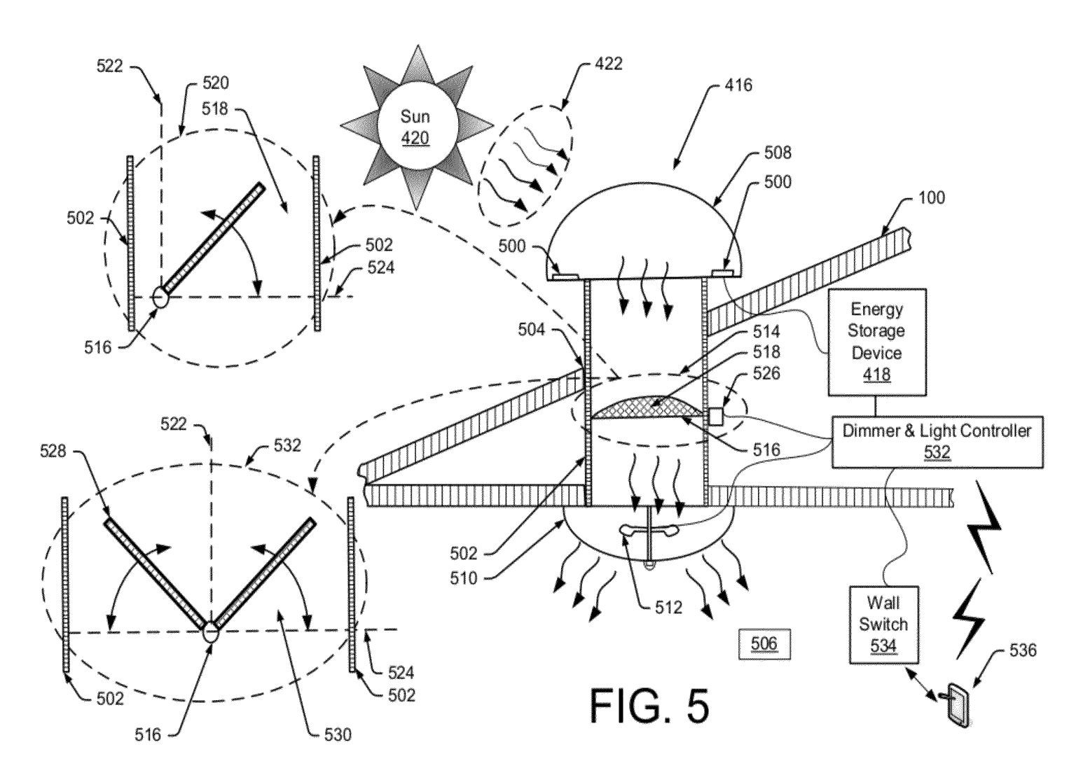

In another embodiment, the prefabricated structure 100 may include a solar energy collection system 416 which may include a solar energy storage device 418 which may be integrated into the electrical delivery and supply system 400. The sun 420 provides light or radiation 422 that is converted to electrical energy by the solar energy collection system 416. The energy storage device 418 may comprise a 12 volt deep cycle battery or one or more double AA batteries. Additionally or alternatively, solar energy may be collected and stored as thermal energy in the form of hot water or other heated liquid or solid material. For example, a solar water heater. An embodiment of the solar collection system 416 will be discussed in greater details in the description of FIG. 5.

### Example Solar Collection Device

FIG. 5 illustrates an embodiment of the solar energy collection system 416 that includes solar energy collection cells 500 that convert solar energy 422 provided by the sun 420 into electrical energy that is stored in an energy storage device 418. The types of solar energy collection cells may include photovoltaic cells, concentrating photovoltaic cells, or thin film solar cells.

In one embodiment, the solar energy collection cells 500 are integrated on to an end of a tube 502 that is coupled an opening in the roof 504 of the prefabricated structure 100. The tube 502 protrudes down to an interior habitable space 506 of the prefabricated structure 100. For example, the living area 244 would be a portion of the interior habitable space 506. Although tube 502 is shown as being straight, it could also bend or curve to direct natural light into the interior spaces. The end of the tube 502 protruding from the opening of the roof 504 may include a translucent or transparent dome 508 that covers the end of the tube 502 and the solar energy collections cells 500 that are arranged around the end of the tube 502. A light globe may be coupled to the opposite end of the tube 502 that protrudes down to the interior habitable space 506 to diffuse natural light into the space during the day. In one embodiment, the light globe may include a translucent dome 510 and an arrangement of lights 512. The lights 512 may include light emitting diodes or any other low voltage direct current light emitting devices. In this embodiment, during the day sun light 422 passes through the dome 508 down through the tube 502 and into the interior habitable space 506. The solar energy collection cells 500 intercept a portion of the light 422 and convert it into electricity that is stored in the energy storage device 418. The stored energy is then used to power the lights 512 at night.

In some embodiments, tube 502 includes a dimmer device 514 or variable light baffle incorporated within the interior volume of the tube. The dimmer device 514 may be configured to block the light 422 from reaching the interior habitable space 506. The dimmer device 514 may include a rod 516 that has both ends coupled to the interior surface of the tube 502. The rod 516 may be coupled to a circular flap 518 that blocks the light from travelling through the tube 502. In the 90 degree cut-away illustration 520 of the dimmer device 514, the rod 516 is located off the vertical center line of the tube 502. When the flap 518 is in the vertical position 522, this enables a large amount of light 422 to reach the interior habitable space 506. In contrast, when the flap 518 is in the horizontal position 524 a lower amount of light 422 reaches the interior habitable space 506. The position of the flap 518 is variable and may move within a 90 degree arc between the vertical position 522 and the horizontal position 524 enabled by an actuation device 526. Alternatively, other light blocking means (e.g., blinds) could be used.

In another embodiment, the flap 518 may also include a solar collection cell integrated into the flap 518 to collect an additional amount of solar energy. The flap 518 solar cell is not shown here for the purpose of ease of illustration. Although FIG. 5 illustrates the dimmer device being located at the center of the tube, the dimmer device may be located at any portion of the tube 502. For example, the dimmer device 514 may be located at the top of the tube 502 to maximize the solar collection capability of the solar collection cell integrated into the flap 518.

In another embodiment, the dimmer device 514, illustrated in the 90 degree cut-away illustration 532, incorporates two semicircular flaps 528 530 attached to rod 516. The rod 516 is positioned along the vertical centerline of the tube 502. In this embodiment the actuation device 526 may actuate the rod 516 or the flaps 528 and 530. The position of the flaps 528 and 530 may vary between vertical position 522 and horizontal position 524 to vary the amount of light that may be blocked by the dimmer device 514. For example, the actuation device 526 actuates the rod 516 or flaps 528 530 to change the angle of the flaps 528 530 to increase or decrease the amount of light 422 that passes through the tube 502 into the interior habitable space 506. Additionally, this embodiment may also include solar collection cells integrated into the flaps 528 530 to generate an additional amount of electricity. These solar cells are not shown in FIG. 5 for the purpose of ease of illustration.

In another embodiment, the dimmer device 514, may be a rod 516 that is attached to a circular flap that may be slightly smaller than the diameter of the tube 502. The rod 516 rotates the circular flap changes its angular position within the tube to block varying amounts of light dependent upon the angle of the circular flap (not shown).

In some embodiments, a dimmer and light controller 532 that includes a user interface, the user interface being a wall switch 534 or a wireless switch 536, that controls the dimmer device 514 and the light arrangement 512. The wireless switch 536 may be attached to the wall or it may be a hand-held device. Also, the energy storage devices 418 or 402 may power the dimmer and light controller 532.

### Example Docking Station

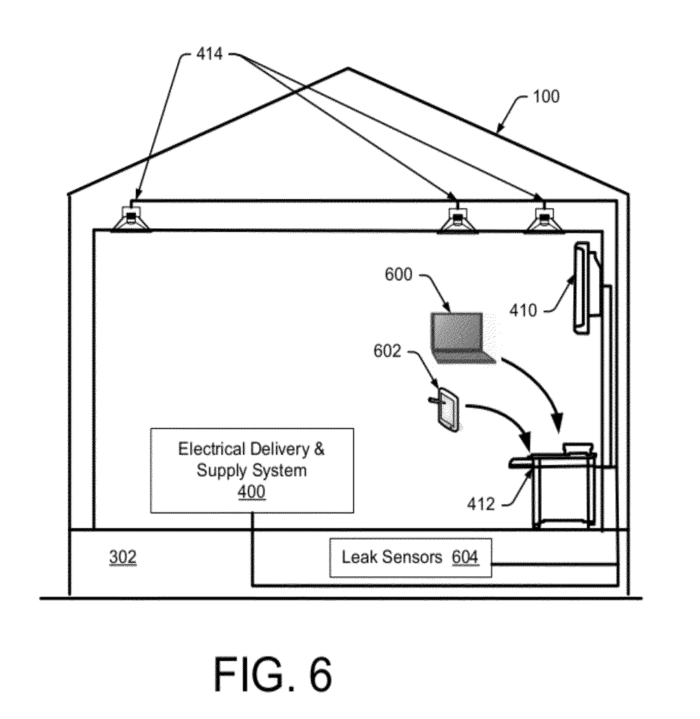

FIG. 6 illustrates a docking station 412 that is integrated into the prefabricated structure 100. The docking station 412 may be configured to receive various electrical devices that may control or interface with other devices, appliances, or fixtures integrated into the prefabricated structure 100.

In one embodiment, a laptop 600 may dock with the docking station 412. The laptop 600 may then interface with other electrical devices incorporated into the prefabricated structure 100. For example, the laptop 600 may control the television 410 by either providing an internet connection via the laptop 600 or a wireless internet router or receiver (not shown). Additionally, the display screen of the laptop 600 may be displayed on the television 412, such that the television 412 acts as the display screen for the laptop 600. Also, a wireless keyboard and mouse (not shown) may interface with the laptop 600 to allow a user to use the television 410 as a display screen for the laptop 600 while being located away from the docking station 412 and/or laptop 600.

In another embodiment, the laptop 600 may interface with speakers 414 that are integrated into the prefabricated structure 100. For example, music played on the laptop 600 may be provided to the speakers 414 to enable music to be heard throughout different portions of the prefabricated structure 100. Also, speakers 414 may be controlled in combination with the television 410 to provide surround sound for images or videos being displayed on the television 410 that are provided by the laptop 600.

In another embodiment, a hand-held device 602 may interface with the docking station 412 to control the television 410, speakers 414, or both. The hand-held device 602 may be a cell phone, a personal data assistant, or any other mobile device that may be used to interface with any electrical system integrated into or residing in the prefabricated structure 100. The hand-held device may also interface to all appliances and fixtures in the habitable structure.

In another embodiment, the laptop 600 may interface with the electrical delivery and supply system 400. For example, the laptop 600 interfaces with the solar power collection system 416 to monitor the status or efficiency of the solar cells 500. Also, the laptop 600 may monitor the status of the energy storage devices 402 and 418 to determine if they need to be replaced or recharged. Similarly, the laptop 600 may also monitor the water supplies 304 and 306 and fuel supply 308 to determine if they need to be replenished or if they are leaking, the leaks may be detected by leak sensors 604 placed in the access space 302. The laptop 602 may also monitor the water pump 314 and the fuel pump 316 to determine if maintenance is required based length of use or historical performance.

### Example Electrical Outlet & Plug

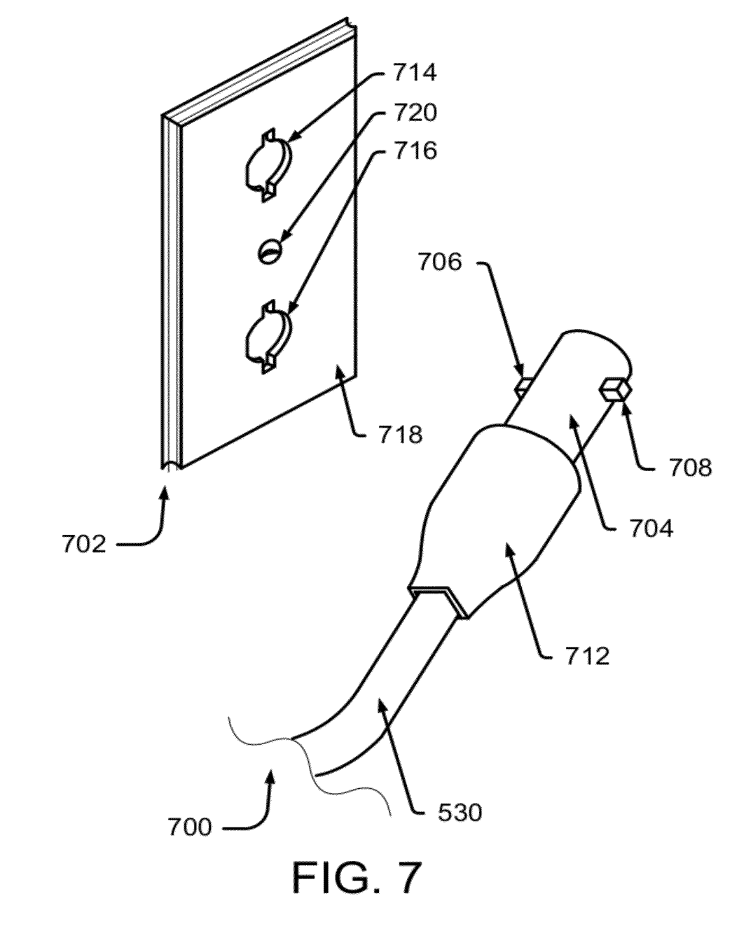

FIG. 7 illustrates a twist lock electrical plug 700 and its corresponding receptacle 702. The plug 700 includes an electrical contact surface 704 that includes two locking elements 706 and 708 and an insulated wire 710. The plug also includes an insulated portion 712 that enables a user to grasp the plug 700 and to twist the plug 700 into a locking position.

In one embodiment, the plug 700 is inserted into a receptacle 702 with the locking elements 706 and 708 properly aligned to clear the receptacle outlets 714 or 716. Once plug 700 is inserted into receptacle 702, the plug 700 can be rotated into a locking position, such that the locking elements 706 and 708 secure the plug so it cannot be pulled out of the receptacle 702 without being rotated to unsecure the locking elements 706 and 708.

In this embodiment, receptacle 702 may be mounted to a wall or other surface that is a convenient location for an electrical outlet in the habitable structure 100. The receptacle 702 may include a face plate 718 that mounts to the wall via a coupler (e.g., screw) 720.

### CONCLUSION

Although the embodiments have been described in language specific to structural features and/or methodological acts, is the claims are not necessarily limited to the specific features or acts described. Rather, the specific features and acts are disclosed as illustrative forms of implementing the subject matter described in the disclosure.

What is claimed is:

1. An apparatus comprising:
a tube comprising a first end and a second end;
a solar energy collection system coupled to the first end of the tube, the solar energy collection system comprising a plurality of solar energy collection devices placed around a circumference of the first end of the tube;
a translucent dome structure coupled to the solar energy collection system that covers the solar energy collection devices and the first end of the tube;
an electrical lighting arrangement coupled to the second end of the tube; and
an energy storage system that stores energy collected by the solar collection devices and provides a low voltage direct current power supply for the electrical lighting arrangement.

2. The apparatus of claim 1, further comprising:
a variable light baffle coupled to an interior surface of the tube to control an amount of light that passes from the first end of the tube to the second end of the tube.

3. The apparatus of claim 2, wherein the variable light baffle comprises:
a rod extending diametrically through the tube;
a first semicircular flap coupled to the rod, the first flap being rotatable around the rod within a 90 degree arc; and
a second semicircular flap coupled to the rod, the second flap being rotatable around the rod within another 90 degree arc.

4. The apparatus of claim 2, wherein the variable light baffle comprises a solar energy collection device on a surface of the first semicircular flap and/or the second semicircular flap.

5. The apparatus of claim 2, further comprising:
an actuation device to rotate the first semicircular flap and the second semicircular flap; and
a remote control communicatively coupled to the actuation device that provides a user interface for the actuation device.

6. The apparatus of claim 2, wherein the electrical lighting arrangement comprises one or more light emitting diodes.

7. The apparatus of claim 2, wherein the tube comprises a curved and/or a bent tube.

8. A solar light comprising
a light transmission structure that receives light at a first point and provides light at a second point;
an energy collection device coupled to the light transmission structure configured to collect sunlight and that provide energy to an energy storage device;
an electrical lighting fixture coupled to the light transmission structure at the second point configured to receive a low voltage direct current power signal from the energy storage device to provide light at the second point;
a transparent or translucent cover that covers the first point of the light transmission structure and the energy collection device;
an adjustable light barrier, in the light transmission structure, configured to control an amount of the light that passes through the light transmission structure.

9. The solar light of claim 8, wherein the adjustable light barrier comprises an energy collection device coupled to a surface of the adjustable light barrier.

10. The solar light of claim 8, wherein the energy storage device comprises a battery.

11. The solar light of claim 8, wherein the energy storage device comprises a deep cycle battery.

12. The solar light of claim 8, wherein the energy storage device comprises a twelve volt battery.

13. The solar light of claim 8, wherein the electrical lighting fixture comprises one or more light emitting diodes.

14. The solar light of claim 8, wherein the light transmission structure comprises a cylindrical tube.

15. The solar light of claim 8, further comprising an actuator box coupled to the light transmission structure to adjust the adjustable light barrier.

16. The solar light of claim 15, further comprising a hand-held remote control device communicatively coupled to the actuator to control an amount of light passing through the light transmission structure.

17. The solar light of claim 15, wherein the light transmission structure comprises a curved and/or a bent tube.

18. A prefabricated building comprising:
an opening on an exterior surface of the prefabricated building;
an opening on an interior surface of the prefabricated building, the opening on the interior surface is connected by a tube to the opening on the exterior surface, such that light entering the opening on the exterior surface is emitted from the opening on the interior surface;
a plurality of energy conversion cells surrounding the opening on the exterior surface that convert solar energy to electrical energy;
an energy storage device configured to receive the electrical energy from the energy conversion cells;
a lighting arrangement coupled to the opening on the interior surface and configured to receive a low voltage direct current electrical signal from the energy storage device.

19. The prefabricated building of claim 18, further comprising a transparent cover coupled to the opening on the exterior surface that covers the opening on the exterior surface and the plurality of energy conversion cells.

20. The prefabricated building of claim 18, wherein the energy storage device comprises a deep cycle battery.

21. The prefabricated building of claim 20, wherein the deep cycle battery operates at twelve volts.

22. The prefabricated building of claim 18, wherein the lighting arrangement comprises one or more light emitting diodes.
